(19) United States
(12) Patent Application Publication
(10) Pub. No.: US 2007/0038496 A1
(43) Pub. Date: Feb. 15, 2007

(54) Workflow engine for managing a worklist and method thereof

(76) Inventors: Shridhar Parvatikar, Cranbury, NJ (US); Debarshi Datta, Old Bridge, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/405,836

(22) Filed: Apr. 18, 2006

Related U.S. Application Data
(60) Provisional application No. 60/694,633, filed on Jun. 28, 2005.

(51) Int. Cl. G06F 9/46

(52) U.S. Cl. 705/8

(57) ABSTRACT

A computer-implemented workflow engine for management of a worklist includes a worklist server interfaced with an information system providing services and storing a worklist entry, a task scheduler coupled to the worklist server, wherein the task scheduler decomposes the worklist entry stored by the worklist server, a task interpreter coupled to the task scheduler, receiving the worklist and separating the worklist into an action and a player, and a task manager coupled to the task scheduler and to the player specified by the worklist.

### CROSS-REFERENCE TO RELATED APPLICATION

This application claims priority to U.S. Provisional Application Ser. No. 60/694,633, filed on Jun. 28, 2005, which is herein incorporated by reference in its entirety.

### BACKGROUND OF THE INVENTION

1. Technical Field

The present invention relates to workflow management, and more particularly to a system and method for an adaptive workflow engine.

2. Discussion of Related Art

Workflow management technology is implemented to organize, automate and improve business processes. Work processes may be divided into component tasks. Defining each task can include specifying who does the work, the information needed, the business rules for how to perform the task, the potential outputs, and who performs a next step in the business process.

Workflow management technology can be used to automate defined processes to meet the needs of the user.

Healthcare is an example of an industry that regularly implements workflow management technology. The healthcare industry's complex business processes can result in difficult to manage information flows. For example, information needed to make clinical decisions may not be readily available or exists in many different forms. Assembling this information can be a difficult task.

Further, as the complexity of delivering health care services has increased, different workflow management solutions have been developed for different tasks. These solutions can be incompatible.

Therefore, a need exists for an adaptive workflow engine system and method of connecting different pieces of workflow management solutions together.

### SUMMARY OF THE INVENTION

According to an embodiment of the present disclosure, a computer-implemented workflow engine for management of a worklist comprises a worklist server interfaced with an information system providing services and storing a worklist entry, a task scheduler coupled to the worklist server, wherein the task scheduler decomposes the worklist entry stored by the worklist server, a task interpreter coupled to the task scheduler, receiving the worklist and separating the worklist into an action and a player, and a task manager coupled to the task scheduler and to the player specified by the worklist.

The workflow engine further comprises a first database coupled to the task interpreter and task manager, wherein the task interpreter populates the first database with information about a first setup of the player. The first database stores a relationship between the action and the player. The first database stores an interpretation of the action. The workflow engine may further comprise a second database coupled to the task interpreter and task manager, wherein the first and the second database store site specific setups.

The workflow engine further comprises a scheduler user interface.

The task scheduler is coupled to a repository for controlling a viewing of data of the worklist.

The task manager is a passive repository of DICOM (Digital Imaging and Communications in Medicine) retention policy service items for enforcing retention and disposition guidelines and component scheduled procedure steps. The task manager drives applications using instructions and data of the worklist to be performed a scheduled task specified by the worklist.

According to an embodiment of the present disclosure, a computer-implemented method for scaling a worklist coupled to a plurality of players comprises providing a worklist server interfaced with an information system providing services and, storing a worklist entry, providing a task scheduler coupled to the worklist server, wherein the task schedule decomposes the worklist entry stored by the worklist server, providing a task interpreter coupled to the task scheduler, receiving the worklist and separating the worklist into an action and a plurality of players, providing a task manager coupled to the task scheduler and to the plurality of players specified by the worklist, and providing at least one database, each database corresponding to a known configuration of the plurality of players and storing a workflow of the plurality of players for performing a task.

The method further comprises scaling the worklist by adding or removing a database.

The method further comprises providing a rule in a database for applying a task of a first configuration of the plurality of players to a task of a second configuration of the plurality of players. The first and second configurations include a set of the plurality of players.

According to an embodiment of the present disclosure, a computer-implemented method for management of a worklist comprises providing a database of worklist patterns, receiving an order for a service at a decision support system, receiving a plurality work items at a task scheduler, inputting the plurality of work items to a task interpreter, searching, by the task interpreter, the database of worklist patterns for a workflow pattern matching each of the plurality of work items, implementing each matching workflow pattern upon determining at least one matching workflow pattern to perform the service, otherwise, determining an alternative workflow pattern, and marking the alternative workflow pattern for review.

The computer-implemented method for management of the worklist further comprises storing the alternative workflow pattern in the database of worklist patterns.

### BRIEF DESCRIPTION OF THE DRAWINGS

Exemplary embodiments of the present invention will be described below in more detail, with reference to the accompanying drawings:

FIG. 1 is a diagram of a workflow management system according to an exemplary embodiment of the present disclosure;

FIG. 2 is a diagram of a worklist server according to an exemplary embodiment of the present disclosure; and

FIG. 3 is a diagram of an intelligent worklist framework or task interpreter according to an exemplary embodiment of the present disclosure;

FIG. 4 is a diagram of a system according to an exemplary embodiment of the present disclosure;

FIG. 5 is an exemplary flow chart of a method for administering a cardiac catheterization according to an embodiment of the present disclosure;

FIG. 6 is an exemplary administrative flow chart of a method for administering a cardiac catheterization;

FIG. 7 is an exemplary administrative flow chart of a method for administering a cardiac catheterization according to an embodiment of the present disclosure; and

FIG. 8 is an exemplary workflow flow chart of affected sections of a sequence implemented by an intelligent workflow framework according to an embodiment of the present disclosure.

### DETAILED DESCRIPTION OF EXEMPLARY EMBODIMENTS

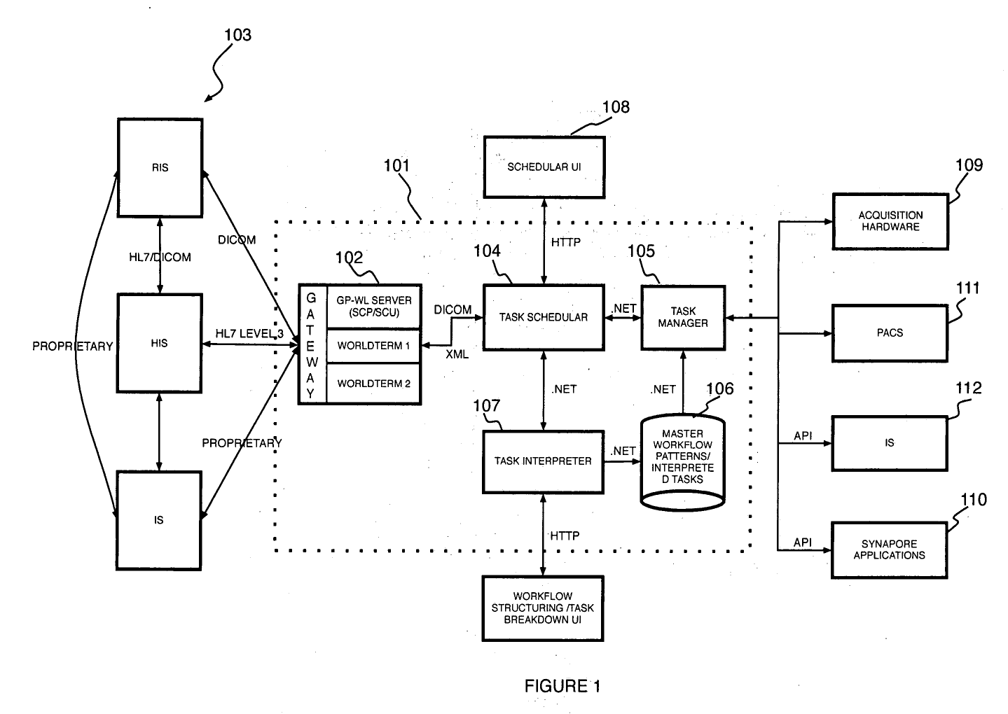

Referring to FIG. 1, according to an exemplary embodiment of the present invention, a workflow management system includes a worklist framework 101 implemented as a workflow engine for event processing. The worklist framework 101 provides application level interfacing techniques, and is conformant to Workflow Integrating the Healthcare Enterprise (IHE) Overview concepts. It should be appreciated by those skilled in the art that a worklist framework 101 can be deployed in different industries and the present invention is not limited to the above mentioned industry.

A method imparts intelligence to a deployed workflow engine (e.g., an open system), which can learn a workflow from use cases performed in a deployed system (e.g., adaptive intelligence) to realize an intelligent workflow management system.

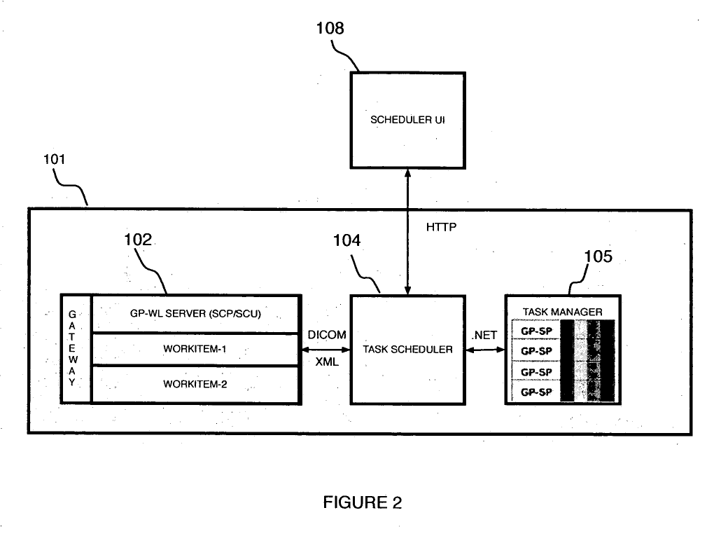

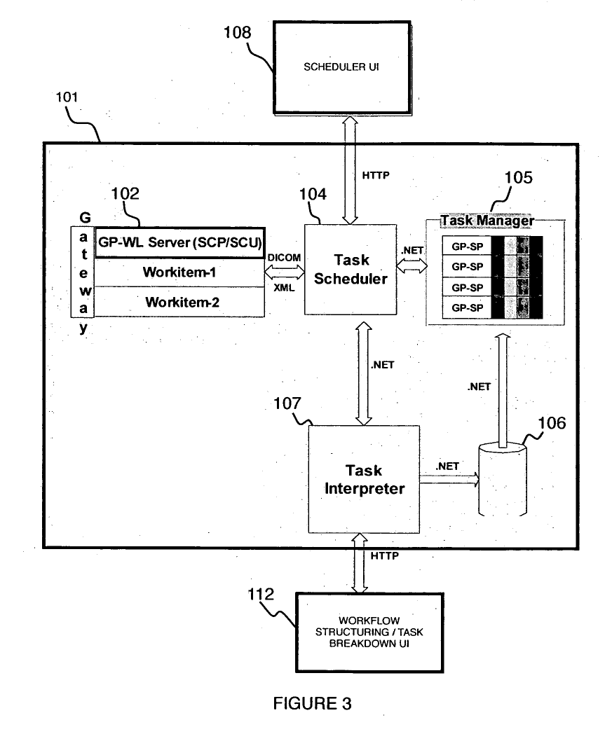

The worklist framework 101 can scale up or down seamlessly, which can be deployed with (see FIG. 3) or without intelligence (see FIG. 2) with a template based, site specific, configurable framework. Enterprise wide reuse and multiple configuration deployment are enabled to satisfy a broad range of workflow management market needs.

Referring to FIG. 1, the worklist framework 101 comprises a General-Purpose Worklist (GPWL) Server 102 implemented as an upstream interface to an information system 103 (IS). The IS 103 may include for example, a hospital database (HIS), radiology scans (RIS), oncology systems, and so on. The GPWL server 102 is modeled as a Digital Imaging and Communications in Medicine (DICOM) service, providing services as a Service Class Provider (SCP) and Service Class User (SCU) to query a worklist from an IS 103, and to serve as a repository for storing general purpose and/or modality worklist entries, status, and progress. The worklist includes scheduled procedure steps or workitems from one or more requested procedures to be performed by a target (e.g., a human, a device, or an application) within the workflow.

The GPWL server 102 facilitates interoperability of equipment, e.g., 103 and 109-112, by specifying for network communications, a set of protocols to be followed by devices, the syntax and semantics of commands and associated information that can be exchanged using the protocols, for media communication, a set of media storage services to be followed by devices, as well as a file format and a medical directory structure to facilitate access to the images and related information stored on interchange media, and information that needs to be supplied with an implementation.

The worklist is the structure to present information related to a particular set of tasks. It specifies particular details for each task. The information supports an order of selection of the tasks to be performed, and supports the performance of the tasks, e.g., the scheduling of imaging procedures or a worklist presented at a radiological reporting station to indicate which studies have been performed and are waiting to be reported.

A service for communicating such worklists includes facilities for querying the worklist, e.g., by an application for performing tasks of the worklist. The facilities may include operations such as search keys. The worklist includes workitems, each workitem is related to a task. A workitem includes attributes from different objects related to the task.

Key attributes of the worklist are employed and may be used as matching key attributes and return key attributes. Matching key attributes may be used for matching. Return key attributes may be used to specify desired return attributes. A worklist service includes an informative overview, an information model definition and a service group.

A task scheduler 104 decomposes the worklist into Retention Policy Service (RPS) items for enforcing retention and disposition guidelines and component Scheduled Procedure Steps (SPS) items for taking ownership of the workitem to substantially prevent simultaneous processing of data (e.g., including notification to RIS that a workitem is in progress). The task scheduler 104 provides a HTTP connection to a user interface (UI) 108 to provide a view of the worklist. The view of the worklist can be a DICOM viewing incorporating the work breakdown of the worklist, and showing the status or progress of the various RPS and SPS. A task scheduler UI 108 allows operations on the worklist, for example prioritization, cancellation, redirection, etc. The task scheduler 104 may have an optional connection to a user repository (like GSM) to allow access control over the data viewing.

A task manager 105 is a manifestation of a workflow engine in the context of the deployment. The task manager 105 receives inputs from the task scheduler 104 and optionally from a master workflow patterns/interpreted tasks database 106.

The task manager 105 is the downstream interface of the worklist framework 101, and interfaces with players (e.g., task performers) listed in the worklist. The task manager 105 provides various levels of services including making available DICOM RPS/SPS to applications as a passive repository, driving applications with instructions and data to perform a scheduled task, etc.

The task manager 105 provides the services over different protocols including DICOM, XML, SOAP, .NET framework interface mechanisms (Remoting, Reflection, Interfaces), Proprietary framework mechanisms (AT.NET), etc. The services of the task manager 105 may be provided to, for example, acquisition hardware 109, Singapore applications 110, Picture Archiving Communication System (PACS) 111 and an IS 112.

A task interpreter 107 breaks down the RPS/SPS/Non-Radiology worklist item to a known set of actions and players. This is achieved thru adaptive learning from the master workflow patterns/interpreted tasks database 106, which includes configuration setup information of a system, e.g., a healthcare enterprise, hospital, department, ward, clinic, observation station, etc.

The task interpreter 107 provides a web interface to populate the master workflow patterns/interpreted tasks database 106 with the information pertinent to the particular setup.

The master workflow patterns/interpreted tasks database 106 is a database, e.g., a relational or XML database. The master workflow patterns/interpreted tasks database 106 stores the configuration setup of the players in a particular deployment, the interpreted task description for the SPS/RPS/IS in the particular context, and the relationship between the actions (e.g., interpretations of the tasks) and players.

The master workflow patterns/interpreted tasks database 106 stores the business logic of the particular deployment. By switching databases, the worklist framework 101 can serve different setups/deployments. The worklist framework 101 can be deployed in an enterprise server configuration, serving up various clinical and departmental workflows (e.g., stored in different databases) from a single installation in a hospital.

Constituents of the worklist framework 101 can be independently deployed across machine boundaries. The communication in between the various constituents can be based on the .NET framework for example. Further, these interactions are modeled on the Service Oriented Architecture, providing inherent multi-user access and multi-client capable solutions

Referring to FIG. 2, the task scheduler 104 performs task breakdown of the known workitems of the GPWL server 102 into a set of standard sub-tasks. The tasks at this level can be handled by any DICOM conformant system.

The scheduler user interface 108 shows the progress of each sub-workitem, and rolled-up task from the DICOM point of view. The scheduler user interface 108 can be a computer having a display, a personal digital assistant, etc.

Referring to FIG. 3, the task interpreter 107 provides a service to teach a deployed system about task breakdown. For example, a player such as, a review station, is disposed downstream, which can handle DICOM hanging protocols. The task interpreter 107 interprets the sub-task review images into a hanging protocol (e.g., action), intended for a particular review station (e.g., the player). The task manager 105 reads an interpreted subtask from the task scheduler 104, and searches the master workflow patterns/interpreted tasks database 106 for pertinent information. If no interpretation exists in the master workflow patterns/interpreted tasks database 106, the interpreted subtask is sent as a DICOM element to the player. If an interpretation exists, the appropriate action request is sent to the player. The interpreted subtask is stored in the master workflow patterns/interpreted tasks database 106 for all future action requests to the same player.

The master workflow patterns/interpreted tasks database 106 acts as a business logic repository for an organization. For example, an organization (e.g., a hospital information system) has three remote sites. Site 1 is an intensive care unit (ICU) center for trauma, Site 2 is a general hospital and Site 3 is a diagnostic clinic. The organization needs to handle different workflows for each of its sites, and link to a central billing/insurance system. The framework shown in FIG. 2 is deployed, including three databases, one for each of the three sites. The task manager 105 runs in an enterprise mode, and connects to one of the three databases based on the context of the request. Organization wide semantics are incorporated in the task scheduler modules 104. Site-specific details of workflow routines are kept in the respective databases 106.

The worklist framework 101 can be deployed in different scenarios. Consider an example in which a deployment needs modality worklist (MWL) specific tasks; optionally replace the upstream module (e.g., the GPWL server 102) with a MWL DICOM service, adapt the task scheduler module 104 to MWL SPS/RPS, program known breakdowns of the workitems into SPS/RPS, and deploy the system in its basic form, or intelligent form.

Referring to FIG. 2, a worklist framework includes a server 102, a task scheduler 104 and a task manager 105. The task scheduler is coupled to a scheduler user interface 108 via an HTML connection. The task scheduler 104 and the server 102 are coupled via a DICOM or XML compliant communication channel. The task scheduler 104 and the task manager 105 are coupled via appropriate programs or components, e.g., .NET components such as LEADTOOLS, communication channel.

Referring to FIG. 3, the size of the database 106 (e.g., the number of databases) determines a scale of the worklist framework. The worklist framework of FIG. 3 is a broker, allowing specific rules to be applied on same tasks in different configurations.

The system is inherently lean, with most of the details being stored in the master workflow patterns/interpreted tasks database 106. Based on the contents of the master workflow patterns/interpreted tasks database 106, the system scales from a worklist management system (see FIG. 2) to an automated, site configured, workflow engine (e.g., see FIG. 3).

Since the business logic of different workflows are stored in the master workflow patterns/interpreted tasks database 106, the worklist system can learn at the deployment site (e.g., prior to deployment), with the aid of the task interpreter 107 and scheduler UI 108. Such prior knowledge in the worklist framework 101 provides inherent intelligence to adaptively learn and perform in the field deployment.

The elements of the worklist framework 101 can be independently deployed across machine boundaries. The communication between the various elements can be based on, for example, the .NET framework.

The interaction between the various elements of the worklist framework 101 can use standard .NET framework components. As these interactions are modeled on a Service Oriented Architecture, they provide multi-user access and multi-client capable solutions.

It is to be understood that the embodiments of the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

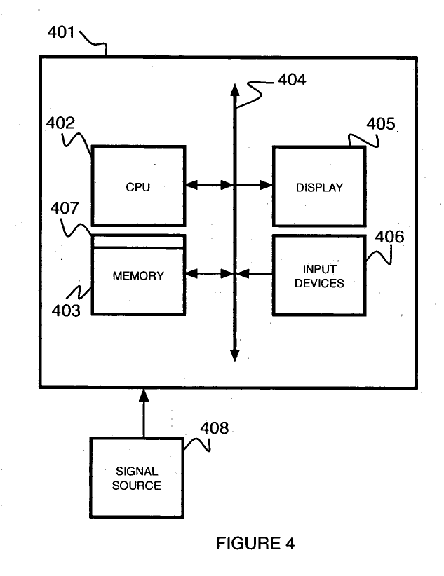

Referring to FIG. 4, according to an embodiment of the present invention, a computer system 401 for implementing a method for automating workflows can comprise, inter alia, a central processing unit (CPU) 402, a memory 403 and an input/output (I/O) interface 404. The computer system 401 is generally coupled through the I/O interface 404 to a display 405 and various input devices 406 such as a mouse and keyboard. The support circuits can include circuits such as cache, power supplies, clock circuits, and a communications bus. The memory 403 can include random access memory (RAM), read only memory (ROM), disk drive, tape drive, etc., or a combination thereof. The present invention can be implemented as a routine 407 that is stored in memory 403 and executed by the CPU 402 to process the signal from the signal source 408. As such, the computer system 401 is a general-purpose computer system that becomes a specific purpose computer system when executing the routine 407 of the present invention.

The computer platform 401 also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Referrig now to an exemplary implementation according to an embodiment of the present disclosure, a new patient entering a healthcare information system results in a set of work items being created for the patient. The work items are translated into GPWL items through a HL7 message or communication. The GPWL server 102 holds the work items. The task scheduler 104 retrieves the work items, breaks them down into various DICOM conformant SPS or RPS sub items, which are scheduled to be performed at various modality workstations, lab, physicians office, etc. The scheduled sub work items are updated as treatment of the patient progresses, enabling tracking and monitoring. The user interface 104 at the task scheduler level provides a means of working on the scheduled sub items or monitoring and taking appropriate actions based on the work progress of the scheduled sub items.

Referring to a system and method for intelligent interpreted integrated worklist management according to an embodiment of the present disclosure: At the task scheduler module 104; once the divided sub items of the work item enter the task scheduler 104, the system asks the task interpreter 107 to further breakdown the sub item into site specific workflow oriented sub process steps.

The task interpreter 107 has access to a database of master workflow patterns 106. Master workflow patterns are the site-defined, detailed, complete process steps to carry out any work item breakdown steps.

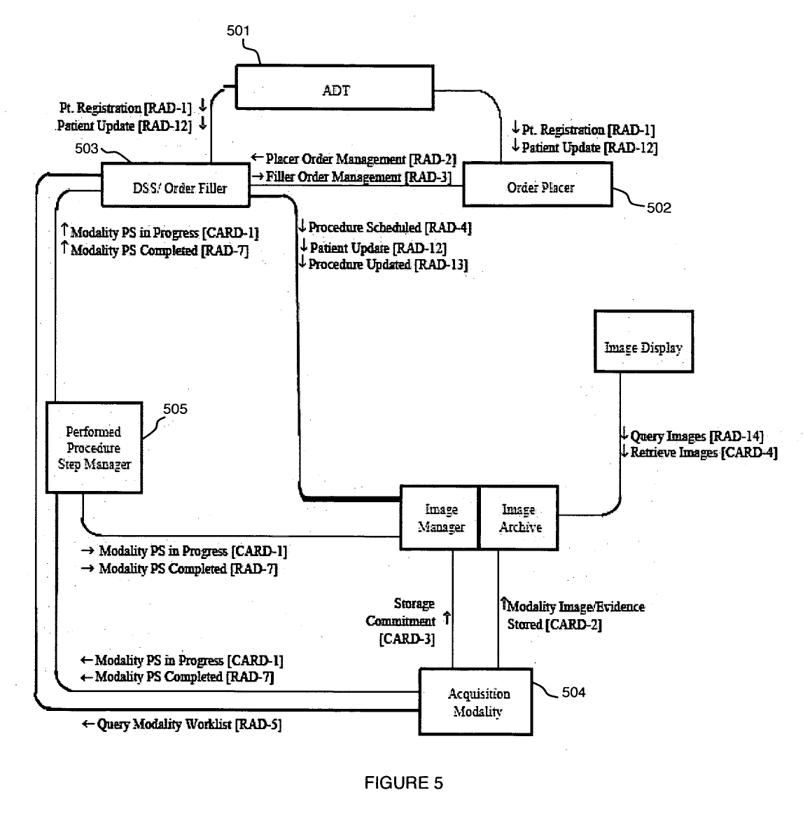

FIG. 5 is an example of a use case for a cardiac catheterization workflow integration as defined by the IHE Cardiac Technical Framework, Vol. I.

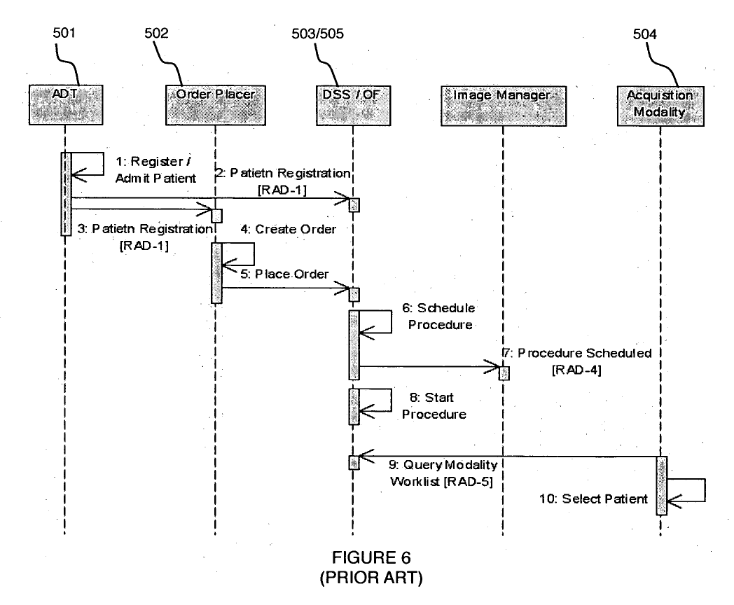

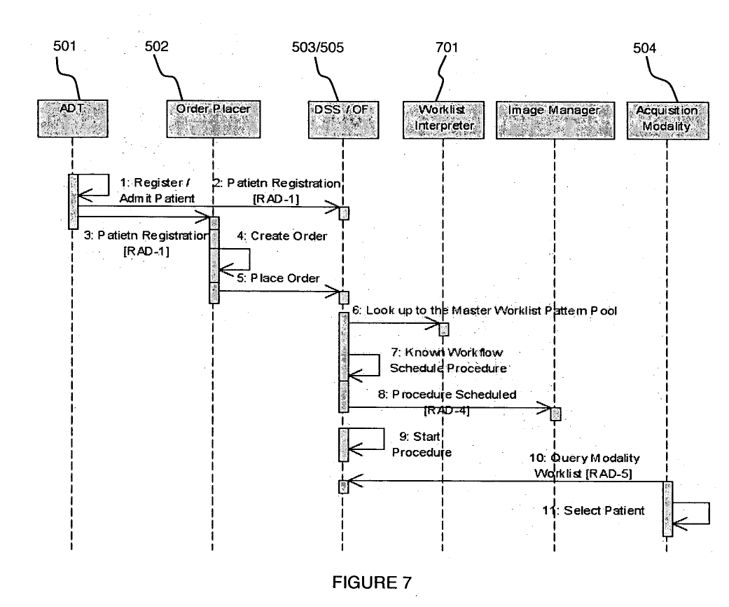

FIGS. 6 and 7 show Administrative workflows corresponding to the case of FIG. 5. In the figures “RAD” indicates work items related to radiology and “CARD” indicates work items related to cardiology. After registering the patient work items in the form of GPWL in the traditional DICOM conformant systems are generated.

Referring to FIG. 5, a process can include several work items, such as, patient registration 501, creating orders for procedures such as lab tests for blood work, electrocardiogram, etc. 502, scheduling the procedures 503, acquiring scheduled procedures at the modality stations 504, performing various procedure steps at the acquisition site 505, etc. Each of these procedure steps will be having has a defined process at any healthcare provider.

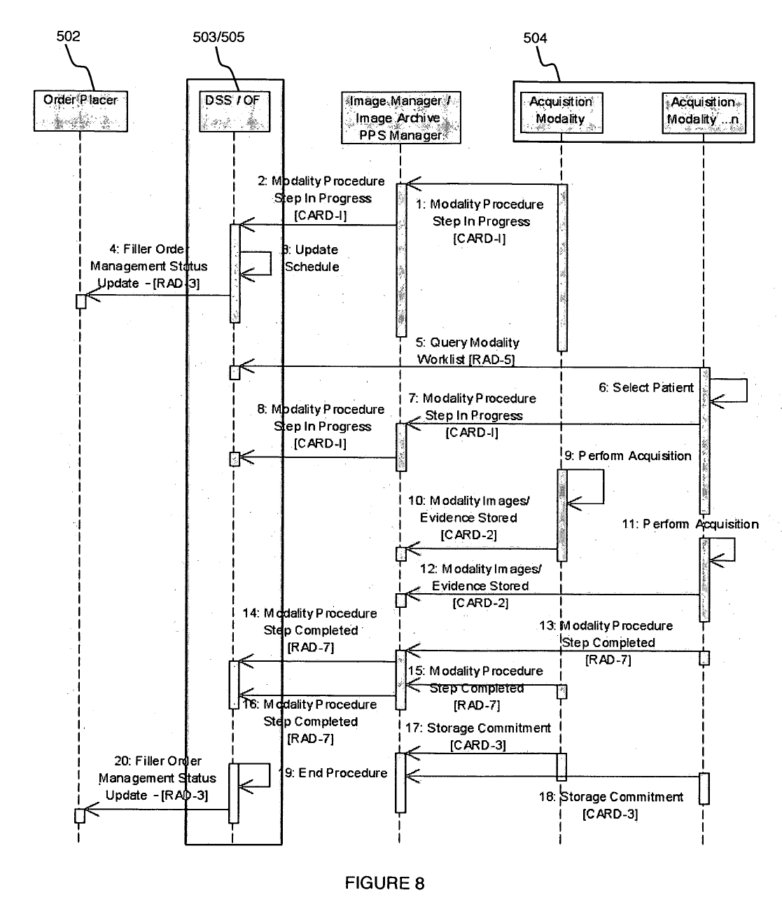

FIG. 8 is an exemplary workflow flow chart of affected sections, e.g., DSS/OF 503/505, of a sequence implemented by an intelligent workflow framework according to an embodiment of the present disclosure.

FIG. 7 illustrates sequences implementing a workflow/method according to an embodiment of the present disclosure. The interpreted workflow management 701 performed by the worklist framework 101 (see FIG. 1) enables a healthcare provider's site to provide their own site optimized, strategically planned, procedural workflow steps to make the master workflow pattern protocols in the database 106. The master workflow pattern protocols are apart from the IHE workflow modeled, or any default master workflow patterns available as preconfigured procedural workflow patterns in the database.

In an intelligent interpreted workflow management system, each process step or sub item, derived from the work item, is input into the task interpreter 107. The task interpreter 107 searches the in the master pattern pool database 106 to find if there is a matching master workflow pattern defined for this particular step. If a match is found then the sub item or SPS or RPS is broken down further into sub steps constituting inputs, outputs, schedules etc. An interface is provided to visualize the interpreted task along with regular scheduled tasks 104. If the task interpreter 107 is not able to find a match in the master pattern pool database 106 containing master workflow patterns the task interpreter 107 provides an alternative workflow pattern. If the alternative workflow pattern is suitable to be carried out, the alternative workflow pattern is marked for review to be constituted as a new master workflow pattern. If accepted upon review by an authorized user, the alternative workflow pattern is stored in the master pattern pool database 106 as a new master workflow pattern.

Taking the example of cardiac catheterization lab workflow of FIG. 5, the catheterization order produced at a decision support system (DSS)/order filler 503 will constitute a broader work item. The work item is pulled in by the GPWL server to constitute a GPWL items. These GPWL items for the cardiac catheterization lab might be blood work, ECG, catheterization procedure, etc. The GPWL items can include other modality specific examination procedure steps. The GPWL items are translated into a set of SPS or RPS. The worklist framework 101 plans, marks and archives as master workflow pattern protocols the sub items or sub process steps in to the master pattern pool database 106.

Having described embodiments for a system and method for worklist framework for a worklist management engine, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A computer-implemented workflow engine for management of a worklist comprising:
a worklist server interfaced with an information system for providing services and storing a worklist entry;
a task scheduler coupled to the worklist server, wherein the task scheduler decomposes the worklist entry stored by the worklist server;
a task interpreter coupled to the task scheduler, for receiving the worklist and separating the worklist into an action and a player; and
a task manager coupled to the task scheduler and to the player specified by the worklist.

2. The workflow engine of claim 1, further comprising a first database coupled to the task interpreter and task manager, wherein the task interpreter populates the first database with information about a first setup of the player.

3. The workflow engine of claim 2, wherein the first database stores a relationship between the action and the player.

4. The workflow engine of claim 2, wherein the first database stores an interpretation of the action.

5. The workflow engine of claim 2, further comprising a second database coupled to the task interpreter and task manager, wherein the first and the second database store respective site specific setups.

6. The workflow engine of claim 1, further comprising a scheduler user interface.

7. The workflow engine of claim 1, wherein the task scheduler is coupled to a repository for controlling a viewing of data of the worklist.

8. The workflow engine of claim 1, wherein the task manager is a passive repository of Digital Imaging and Communications in Medicine (DICOM) retention policy service items for enforcing retention and disposition guidelines and component scheduled procedure steps.

9. The workflow engine of claim 1, wherein the task manager drives applications using instructions and data of the worklist to performed a scheduled task specified by the worklist.

10. A computer-implemented method for scaling a worklist coupled to a plurality of players comprising:
providing a worklist server interfaced with an information system for providing services and storing a worklist entry;
providing a task scheduler coupled to the worklist server, wherein the task schedule decomposes the worklist entry stored by the worklist server;
providing a task interpreter coupled to the task scheduler, for receiving the worklist and separating the worklist into an action and a plurality of players;
providing a task manager coupled to the task scheduler and to the plurality of players specified by the worklist; and
providing at least one database, each database corresponding to a known configuration of the plurality of players and storing a workflow of the plurality of players for performing a task.

11. The computer-implemented method of claim 10, further comprising scaling the worklist by adding or removing a database.

12. The computer-implemented method of claim 10, further comprising providing a rule in a database for applying a task of a first configuration of the plurality of players to a task of a second configuration of the plurality of players.

13. The computer-implemented method of claim 12, wherein the first and second configurations include a set of the plurality of players.

14. A computer-implemented method for management of a worklist comprising:
providing a database of worklist patterns;
receiving an order for a service at a decision support system;
receiving a plurality work items at a task scheduler;
inputting the plurality of work items to a task interpreter; and
searching, by the task interpreter, the database of worklist patterns for a workflow pattern matching each of the plurality of work items,
implementing each matching workflow pattern upon determining at least one matching workflow pattern to perform the service, otherwise,
determining an alternative workflow pattern, and marking the alternative workflow pattern for review.

15. The computer-implemented method for management of the worklist of claim 14, further comprising storing the alternative workflow pattern in the database of worklist patterns.
